(19) United States
(12) Patent Application Publication
(10) Pub. No.: US 2003/0001697 A1
(43) Pub. Date: Jan. 2, 2003

(54) Resonance suppressed stepped-impedance low pass filter and associated method of fabrication

(75) Inventors: Richard L. Bennett, Torrance, CA (US); Paul J. Tatomir, Fallbrook, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 09/885,182

(22) Filed: Jun. 20, 2001

(51) Int. Cl. H01P 1/20

(52) U.S. Cl. 333/202; 333/204; 333/206; 333/208

(57) ABSTRACT

An improved stepped-impedance low pass filter includes a stepped-impedance low pass filter having at least one electrically conductive transmission line, such as a parallel plate, coaxial, or two-wire transmission line, having at least one inductive element and at least one capacitive element. The capacitive elements and the inductive elements are disposed in an alternating manner along a length of the transmission line. The resonance suppressed stepped-impedance low pass filter also includes at least one electrically conductive suppression element disposed along the inductive elements of the stepped-impedance low pass filter, such as centered along the inductive elements between pairs of capacitive elements. The suppression elements suppress a spurious response at at least one resonant frequency.

### FIELD OF THE INVENTION

The present invention relates generally to electrical filters and associated methods of fabrication and, more particularly, to stepped-impedance low pass filters and associated methods of fabrication.

### BACKGROUND OF THE INVENTION

Generally, microwave filters can be described as frequency-selective signal transmission devices that allow the passage of certain ranges of frequencies (i.e., low pass, high pass, band pass or band reject) from an input to an output, while other ranges are rejected. Today filters are widely used in all types of electrical applications, from audio and communications to signal processing. Audio systems use filters to perform functions such as preamplification, equalization and tone control. In communications applications, filters are used to perform functions such as the tuning of specific frequencies and the elimination of other frequencies. In telephony applications, filters are used to decode tone frequencies used for dialing digits. Signal processing applications use filters for functions such as anti-aliasing.

Typically, microwave filters are created by first designing the filter based upon a desired set of properties. Generally, microwave filters are designed by first selecting a lumped-element circuit to approximate the desired set of properties, consisting of circuit elements such as resistors, capacitors and inductors. After the filter has been designed, the filter is then fabricated. One typical method of fabricating filters is to realize the designed lumped-element circuit using short lengths of a transmission line, such as a coaxial line, microstrip or strip-line transmission line.

One type of filter, a low pass filter, allows the passage of low frequencies down to and including direct current (DC), 0 Hz, while high frequencies up to and including infinite frequencies are rejected. The range of frequencies that are allowed through the filter is commonly referred to as the pass band of the filter, while the highest frequency allowed to pass through the filter is called the cut-off frequency. Additionally, low pass filters are typically characterized by their insertion loss, which describes the amount of attenuation of the signal between the input and the output at each frequency. Generally, in low pass filter design, the lumped-element circuit is selected based upon characteristics of the filter such as the desired pass band, cut-off frequency and minimum insertion loss at a specified frequency outside the pass band.

Referring to FIG. 1A, in one common low pass filter design, the lumped-element circuit consists of one or more series inductors L₁-L_{N} alternating with one or more shunt capacitors C₁-C_{N}. In one common realization of such a lumped-element circuit, the low pass filter consists of alternating sections of very high and very low characteristic impedance transmission line sections. This type of filter is commonly referred to as a stepped-impedance low pass filter. In stepped-impedance low pass filters, the high-impedance sections simulate the series inductances of the lumped-element circuit, while the low-impedance sections simulate the shunt capacitances of the lumped-element circuit.

FIGS. 1B and 1C illustrate a common stepped-impedance low pass filter realized from a lumped-circuit similar to that illustrated in FIG. 1A, using a coaxial transmission line and a strip-line transmission line, respectively. The coaxial line stepped-impedance low pass filter 10 consists of a coaxial transmission line that includes an outer conductor 12 and an inner conductor structure 14, separated from one another by a dielectric 18. Surrounding the outer conductor, the coaxial transmission line includes an outer insulating jacket 16 to protect the transmission line. The inner conductor structure includes short high-impedance conductor sections 20 that simulate the inductances of the lumped-element circuit. In between inductive sections, the inner conductor structure includes low-impedance disks 22, typically surrounded by a stabilizing dielectric rim (not shown), that simulate the capacitances of the lumped-element circuit. Also, typically the inductive sections are separated from the dielectric, and the inductive sections and capacitive disks are separated from one another, by a spacing dielectric 24, such as air.

Referring to FIG. 1C, a common strip-line stepped-impedance low pass filter 30 includes a low-loss dielectric sheet 32 with a center conductor 38 disposed thereon. Optionally, the filter may include another dielectric sheet (not illustrated) on top of the center conductor to sandwich the center conductor, and an outer conductor on the outer surfaces of the dielectric sheets to serve as ground planes for the center conductor. Like the inner conductor of the coaxial stepped-impedance low pass filter 10, the center conductor of the strip-line stepped-impedance low pass filter includes short sections of high-impedance conductor sections 34 that simulate the inductances of the lumped-element circuit, alternating with short sections of low-impedance conductor sections 36 that simulate the capacitances of the lumped-element circuit. For a further discussion of conventional filter design, see George L. Matthaei et al., MICROWAVE FILTERS, IMPEDANCE-MATCHING NETWORKS, AND COUPLING STRUCTURES (1980) (particularly Chapter 7).

While conventional stepped-impedance low pass filters such as those described above are adequate for many applications, they have drawbacks. Among other drawbacks, the inductive sections of conventional stepped-impedance low pass filters produce unwanted spurious responses at resonant frequencies outside the pass band. At the resonant frequencies, the length of the inductive sections approach one-half wavelength of the transmission line which cause the filter to act as a coupled resonator band pass filter. The spurious responses degrade the rejection of low pass filter, and typically requires the addition of a second low pass filter, with a higher frequency band pass, to maintain the desired frequency rejection. But adding the second low pass filter can undesirably add to the insertion loss of the filter within the pass band. Additionally, the second low pass filter typically adds size and cost to the resulting filter network.

### SUMMARY OF THE INVENTION

In light of the foregoing background, the present invention provides an improved stepped-impedance low pass filter and associated method of fabrication that reduce the spurious responses and/or resonant frequencies produced by conventional stepped-impedance low pass filters without the need or associated drawbacks of adding a second low pass filter. According to one embodiment of the present invention, a resonance suppressed stepped-impedance low pass filter includes a stepped-impedance low pass filter having at least one electrically conductive transmission line, such as a parallel plate, coaxial, or two-wire transmission line, with at least one inductive element and at least one capacitive element. The capacitive elements and the inductive elements are disposed in an alternating manner along a length of the transmission line. In order to produce a predetermined response over a predetermined frequency range, the level of capacitance and inductance of the capacitive and inductive elements, respectively, can selected based upon at least one filter performance characteristic, such as a predetermined cut-off frequency, a minimum predetermined insertion loss at a specified frequency, a filter impedance, and a maximum and a minimum transmission line impedance.

The resonance suppressed stepped-impedance low pass filter also includes at least one electrically conductive suppression element disposed along the inductive elements of the stepped-impedance low pass filter, such as centered along the inductive elements between pairs of capacitive elements. The suppression elements suppress the spurious responses and/or reduce the resonant frequencies. For example, each suppression element can have a capacitance that is selected based upon the level of the spurious response and the location of at least one resonant frequency in order to reduce the spurious response and/or the resonant frequencies.

In another embodiment of the present invention, a stepped-impedance low pass filter has at least one electrically conductive transmission line. At least a portion of the transmission line includes at least one base element having a first portion and a second portion selected so that the first portion has a lower impedance than that of the second portion. At least a portion of the transmission line also includes at least one intermediate element disposed along the second portion of the base element. The intermediate element is selected so that the intermediate element has an impedance lower than the second portion, but larger than the first portion. In a further embodiment, the transmission line includes at least two base elements. In this embodiment, the second portion of one base element is connected to the first portion of a subsequent base element so that the intermediate elements are disposed between a pair of first portions, such as centered along the second portions of the base elements. In one embodiment, the stepped-impedance low pass filter further includes a dielectric, such as air, between each pair of first portions.

The present invention also provides a method for fabricating the resonance suppressed stepped-impedance low pass filter. First, a stepped-impedance low pass filter, including at least one electrically conductive transmission line having inductive elements and capacitive elements, is created. Then, at least one electrically conductive suppression element is disposed along the inductive elements to suppress the spurious response and/or the resonant frequencies. For example, the suppression elements can be centered along the inductive elements between pairs of capacitive elements. The suppression elements can be selected based upon the level of the spurious response and the resonant frequencies in order to reduce the spurious responses and/or the resonant frequencies.

In one embodiment, the resonance suppressed stepped-impedance low pass filter is next optimized after the suppression elements are disposed along the inductive elements. In this embodiment, the resonance suppressed stepped-impedance low pass filter is optimized based upon at least one actual performance characteristic, such as a measured cut-off frequency, a measured insertion loss at a specified frequency, a measured filter impedance, and a measured maximum and a measured minimum transmission line impedance. In another embodiment, the stepped-impedance low pass filter is created by first creating the stepped-impedance low pass filter based upon at least one theoretical performance characteristic, such as a predetermined cut-off frequency, a predetermined minimum insertion loss at a specified frequency, a filter impedance, and a maximum and a minimum transmission line impedance. In another embodiment, after the stepped-impedance low pass filter is created, the stepped-impedance low pass filter is optimized based upon the actual performance characteristics.

Therefore, the present invention provides a resonance suppressed stepped-impedance low pass filter and associated method of fabrication that improve upon conventional stepped-impedance low pass filters. The resonance suppressed stepped-impedance low pass filter of the present invention reduces the spurious responses and/or resonant frequencies produced by conventional stepped-impedance low pass filters without the need or associated drawbacks of additional low pass filters.

### BRIEF DESCRIPTION OF THE DRAWINGS

Having thus described the invention in general terms, reference will now be made to the accompanying drawings, which are not necessarily drawn to scale, and wherein:

FIG. 1A is a schematic diagram of a conventional lumped-element low pass filter circuit;

FIG. 1B is a perspective view of a common coaxial stepped-impedance low pass filter realized from a lumped-circuit similar to that illustrated in FIG. 1A;

FIG. 1C is a top plan view of a common strip-line stepped-impedance low pass filter realized from a lumped-circuit similar to that illustrated in FIG. 1A;

FIG. 2 is a perspective view of a coaxial resonance suppressed stepped-impedance low pass filter according to one embodiment of the present invention;

FIG. 3 is a cross-section view of the coaxial resonance suppressed stepped-impedance low pass filter taken along line 3-3 of FIG. 2;

FIG. 4 is a top plan view of a strip-line resonance suppressed stepped-impedance low pass filter according to one embodiment of the present invention;

FIG. 5 is a flow chart illustrating one embodiment of a method of fabricating a coaxial resonance suppressed stepped-impedance low pass filter according to the present invention;

FIG. 6 is a schematic diagram of a lumped-element circuit representation of the resonant suppressed stepped-impedance low pass filter according to one embodiment of the present invention; and

FIG. 7 is a graph illustrating how the resonance suppressed stepped-impedance low pass filter, according to one embodiment, reduces the spurious responses and/or resonant frequencies over a conventional stepped-impedance low pass filter.

### DETAILED DESCRIPTION OF THE INVENTION

The present invention now will be described more filly hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

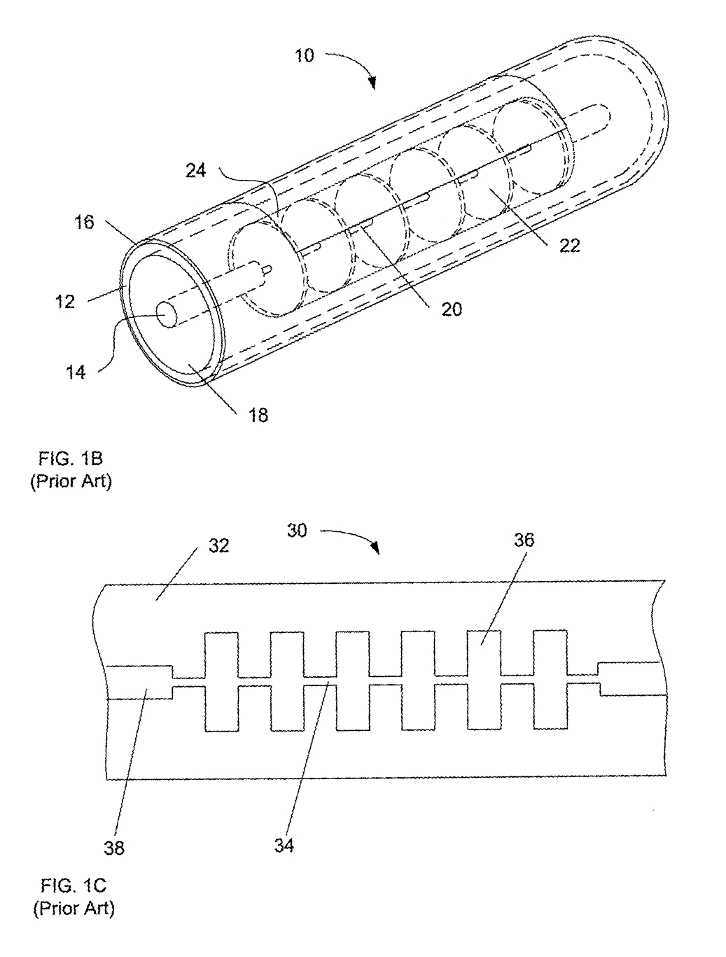

As illustrated in FIGS. 2, 3 and 4, the resonance suppressed stepped-impedance low pass filter of the present invention can be realized with a coaxial or strip-line transmission line, respectively. But it should be understood the illustrated embodiments are for illustrative purposes only. The resonance suppressed stepped-impedance low pass filter can be realized with other types of transmission lines, such as parallel plate transmission lines (including micro-strip and the aforementioned strip-line) and two-wire transmission lines, without departing from the spirit and scope of the present invention.

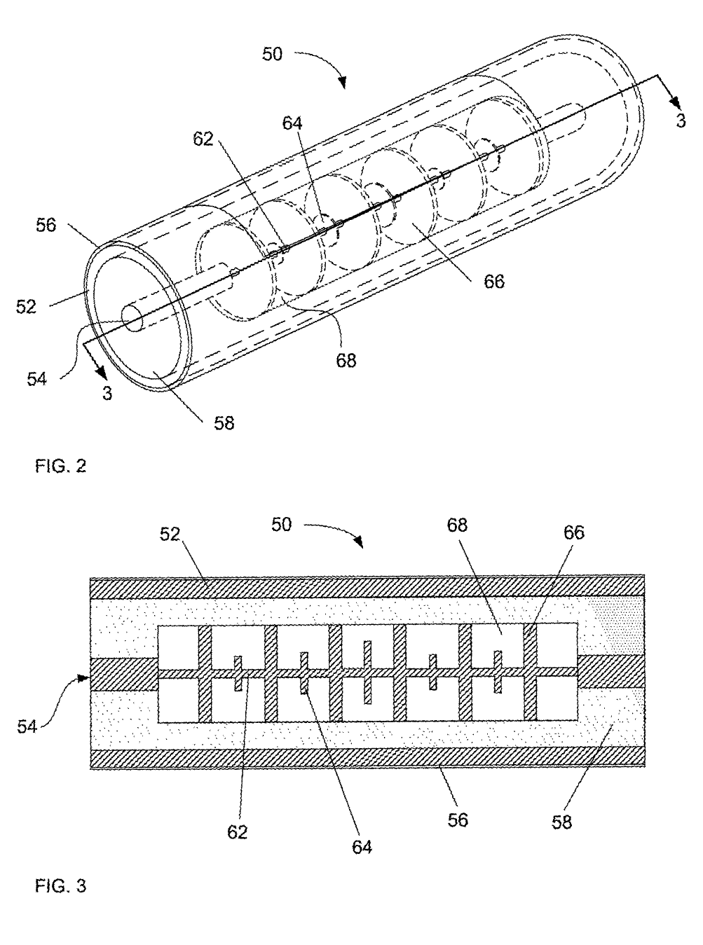

Referring to FIGS. 2 and 3, as realized with a coaxial transmission line, the resonance suppressed stepped-impedance low pass filter 50 of one embodiment of the present invention includes a stepped-impedance low pass filter and at least one suppression element 64. The stepped-impedance low pass filter has an outer conductor 52 and an inner conductor structure 54 that form the signal transmission line of the filter. The outer conductor and inner conductor structures can be formed of a variety of different conductive materials as such are known to those skilled in the art, but in one embodiment the outer conductor and inner conductor structure are formed from a copper material. Separating the outer conductor and inner conductor structures, the stepped-impedance low pass filter includes a dielectric 58. The dielectric can be made from a variety of different materials including, for example, rubber, ethylene propylene diene monomer (EPDM), neoprene and hypalon, polyethylene (PE), polypropylene, poly-vinyl chloride (PVC), foamed polyethylene (FPE) and polytetrafluoroethylene (PTFE). Surrounding the dielectric the stepped-impedance low pass filter can include an insulating jacket 56 made from a variety of different materials, such as PE or PVC, as known to those skilled in the art.

The inner conductor structure of the stepped-impedance low pass filter includes at least one, and more typically, a plurality of base elements, each having first and second portions. The first portion of each base element has a lower impedance than the second portion. As illustrated, each base element preferably has a first portion formed of a capacitive, or electrically conductive, element 66 and a second portion formed of an inductive element 62, or connecting member. Separating the capacitive elements from the dielectric 58, the capacitive elements can be surrounded by a dielectric, such as a dielectric rim, (not shown) that maintains the inner conductor structure in alignment within the dielectric. Between the inductive elements and the dielectric, and between the capacitive elements, the resonance suppressed stepped-impedance low pass filter includes a spacing dielectric 68. The spacing dielectric can be made from a variety of materials, but in a preferred embodiment the spacing dielectric is air.

The inductive elements 62 and capacitive elements 66 of the inner conductor structure 54 are selected to have relatively high and low impedances, respectively, such that the elements simulate the inductors and capacitors of a selected lumped-element circuit representation of the resonant suppressed stepped-impedance low pass filter 50, as described below. Also described below, the size and number of the inductive elements and capacitive elements generally depend upon the desired performance characteristics of the resonant suppressed stepped-impedance low pass filter, such as the cut-off frequency, minimum insertion loss at a specified frequency and relative impedances of the various elements of the inner conductor structure.

As previously stated, a drawback of conventional stepped-impedance low pass filters is the existence of spurious responses at resonant frequencies above the allowed pass band. To reduce these spurious responses and/or resonant frequencies, the resonant suppressed stepped-impedance low pass filter 50 also includes at least one suppression, or intermediate, element 64 disposed along the inductive elements 62 and in between pairs of the capacitive elements 66. Typically, the suppression elements have an impedance that ranges between the impedance of the inductive elements and the impedance of the capacitive elements. The suppression elements can be made from a variety of different electrically conductive materials, as such are known. But in a preferred embodiment, the suppression elements are made from the same type of material as, and are integral with, the inner conductor structure 54 of the stepped-impedance low pass filter.

While the suppression elements 64 can be placed at any location along the inductive elements 62, depending upon the desired output of the resonant suppressed stepped-impedance low pass filter 50, in a preferred embodiment the suppression elements are centered along the inductive elements between the capacitive elements 66. The diameters of the suppression elements are also dependent upon the desired output. The suppression elements typically consist of different sizes to spread the remaining, reduced spurious response over a wider range of new, lower resonant frequencies, with the resonant frequencies decreasing as the diameter of the suppression elements increases. Also, whereas each suppression element can have a variety of different widths, in one embodiment the width of each suppression element is selected to approximately one-tenth the length of the inductive element along which the respective suppression element is disposed. It should be understood, however, that the suppression elements can each have a different width from the other suppression elements without departing from the spirit and scope of the present invention.

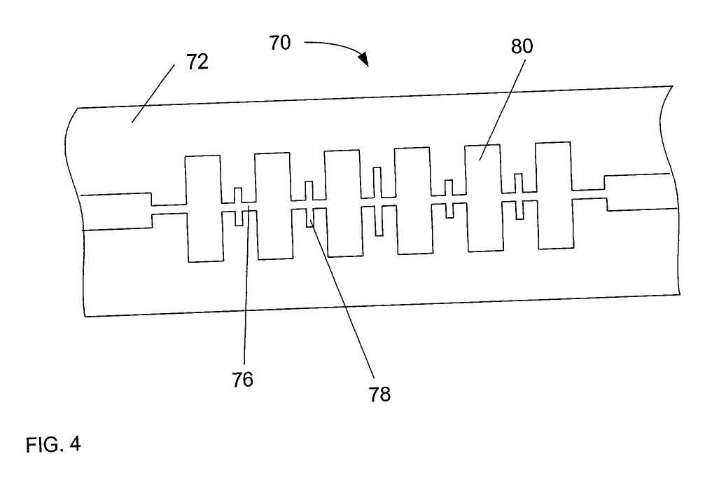

FIG. 4 illustrates another embodiment of the resonant suppressed stepped-impedance low pass filter 70, realized with a strip-line transmission line. The strip-line realization includes a dielectric sheet 72, made from any one of a variety of different materials, including thermoset materials such as rubber, EPDM, neoprene and hypalon, or thermoplastic materials such as PE, polypropylene, PVC and FPE. Disposed upon the dielectric sheet, the resonant suppressed stepped-impedance low pass filter includes a center conductor structure. The center conductor structure can be made of a variety of different materials, but is preferably a copper foil. Additionally, the center conductor structure can be disposed upon the dielectric sheet by any of a number of different methods, such as by photo-etching onto the dielectric sheet.

The center conductor structure comprises at least one inductive element 76 and at least one capacitive element 80. Disposed along the inductive elements, the strip-line realization of the resonant suppressed stepped-impedance low pass filter 70 includes at least one suppression element 78. The size of the suppression elements are selected based upon the desired output of the resonant suppressed stepped-impedance low pass filter and the spurious response at the resonant frequencies. Optionally, and not illustrated, the strip-line resonant suppressed low pass filter may include an additional dielectric sheet disposed on top of the center conductor to sandwich the center conductor in between dielectric sheets. On the outside surfaces of the dielectric sheets, the strip-line may include outer conductors, such as copper foil conductors or metal plate conductors, to serve as ground plates for the strip-line transmission line.

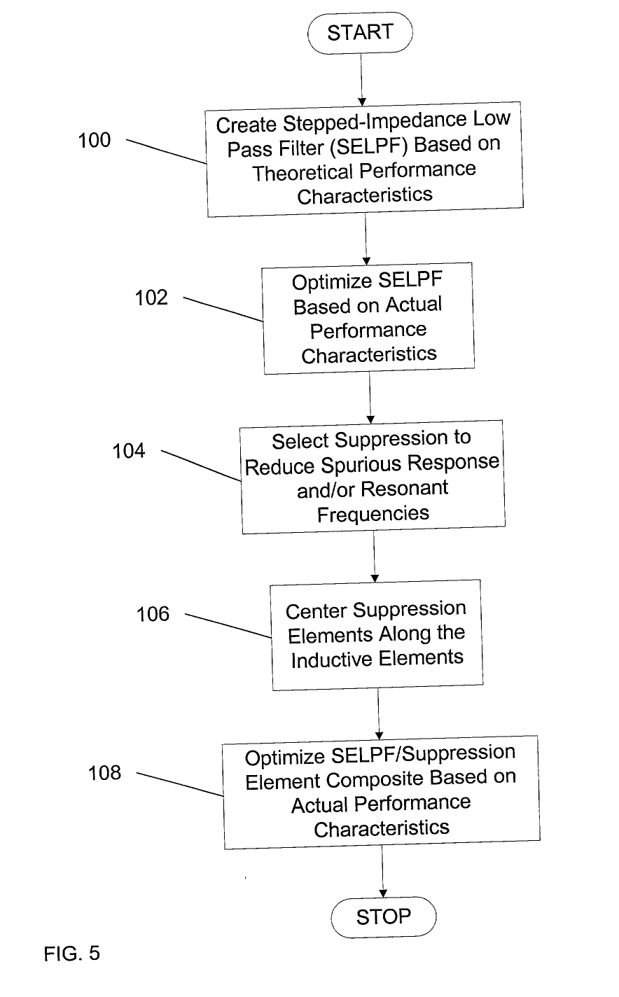

Referring now to FIG. 5, the present invention also provides a method of fabricating the resonant suppressed stepped-impedance low pass filter. According to one embodiment, the fabrication of a stepped-impedance low pass filter begins with the creation of the stepped-impedance low pass filter (block 100). Creation of the stepped-impedance low pass filter typically begins by selecting a lumped-element circuit that has theoretical, desired performance characteristics for a particular low pass filter application. For a particular application it may be desirable to select a low pass filter that has desired performance characteristics, such as a cut-off frequency of f_{c}, Hertz (Hz) with a minimum insertion loss of A dB at fHz. Additionally, the lumped-element circuit typically also specifies characteristics relating to the desired transmission line of the realized filter, such as the filter impedance Zₒ Ohms (Ω), the highest practical transmission line impedance Zₕ Ω and the lowest practical transmission line impedance Zₗ Ω. For example, in one application it could be desirable to select a 0.01 dB ripple Chebyshev filter with a cut-off frequency of 3,900 MHz with an insertion loss of more than 60 dB at 5,500 MHz. For the realization of the filter, the transmission line has a line impedance of 50 Ω, and high and low practical line impedances of 130 Ω and 7 Ω, respectively.

Once the characteristics of the low pass filter have been determined, selection of the lumped-element circuit can be accomplished via a number of different methods, as such are known to those skilled in the art. For example, the lumped-element circuit can be selected using a computer software package, such as the Touchstone software package available from Agilent Technologies, Inc. of Palo Alto, Calif. Additionally, or alternatively, the selection of the lumped-element circuit can be accomplished by using a series of equations and look-up tables to approximate the number and values of the elements of the lumped-element circuit. Using the equations and look-up tables, the number of elements that the circuit requires to achieve the desired, theoretical characteristics can be determined by first calculating the normalized frequency, a, from the following equation:

$$a = \vert \frac{f}{{f}_{c}} \vert - 1 \qquad ( 1 )$$

Using the normalized frequency and minimum insertion loss, the number of elements required for the lumped-element circuit can then be determined from a look-up table, such as are known to those skilled in the art. In the above example, using a calculated normalized frequency of 0.410 and the desired insertion loss of 60 dB for a 0.01 dB ripple Chebyshev filter, the number of elements required for the lumped-element circuit is 13.

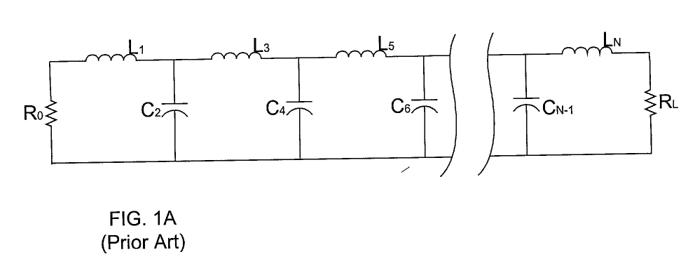

The number of required elements and the fact that stepped-impedance low pass filters generally alternate between series inductors and shunt capacitors, as illustrated in FIG. 1, can be used to determine normalized element values for the lumped-element circuit, again from a look up table, known to those skilled in the art. From the look up table, a lumped-element circuit requiring seven elements would contain alternating series inductors and shunt capacitors having the following normalized values: L1′=L13′=0.8287, C2′=C12′=1.454, L3′=L11′=1.8437, C4′=C10′=1.7594, L5′=L9′=1.9777, C6′=C8′=1.8134 and L7′=2.0014. To obtain the actual element values, the normalized values need to by scaled based upon the line impedance Zₒ and the cut-off frequency f_{c} using the following equations:

$$\begin{matrix}L = \frac{{Z}_{o} \times {L}^{′}}{{f}_{c} \times 2 \times π} & ( 2 ) \\ C = \frac{{C}^{′}}{{Z}_{o} \times {f}_{c} \times 2 \times π} & ( 3 )\end{matrix}$$

From equations (2) and (3), the lumped-element circuit has elements with the following values: L1=L13=1.691 nH, C2=C12=1.187 pF, L3=L11=3.762 nH, C4=C10=1.436 pF, L5=L9=4.034 nH, C6=C8=1.480 pF and L7=4.084 nH. Whereas the example, and illustrated embodiments, include alternate inductive and capacitive elements beginning with an inductive element, it should be understood that the stepped-impedance low pass filter and, thus, the resonant suppressed stepped-impedance low pass filter, can begin with a capacitive element without departing from the spirit and scope of the present invention.

After the lumped-element circuit has been selected, the dimensions of the realized stepped-impedance low pass filter are determined based upon the selected transmission line, such as are known to those skilled in the art. For example, a particular realization may utilize a coaxial transmission line having an outer conductor with an inner radius, b. Typically, the outer conductor of the coaxial transmission line is selected as desired, with the other dimensions calculated based upon the desired lumped-element circuit realization. Additionally, the dielectric in between the outer conductor and inner conductor structure has a dielectric constant, εᵣ, such as approximately 2 for the dielectric PTFE. For example, if fringing effects produced at the junctions between each of the elements of the inner conductor structure are ignored, the dimensions of the inductive elements of the coaxial transmission line stepped-impedance low pass filter can be approximated from the following equations (4) and (5):

$$\begin{matrix}L = \frac{{Z}_{h}}{2 \times π \times {f}_{c}} \times sin ( \frac{2 \times π \times {f}_{c} \times {l}_{L}}{{c}_{L}} ) & ( 4 ) \\ {Z}_{h} = \frac{60}{\sqrt{{ϵ}_{r}}} \times ln ( \frac{b}{{a}_{L}} ) & ( 5 )\end{matrix}$$

In equations (4) and (5), l_{L} is the length of the respective inductive element, a_{L} is the inner conductor structure radius of the respective inductive element, and c_{L} is the effective propagation velocity for the respective inductive element which, in the example, equals the velocity of light in free space, or 1.1803×10¹⁰ in/sec. Also, again neglecting the fringing effects, the dimensions of the capacitive elements of the coaxial transmission line stepped-impedance low pass filter can be approximated from the following equations (6) and (7):

$$\begin{matrix}C = \frac{{l}_{C}}{{Z}_{L} \times {c}_{C}} & ( 6 ) \\ {Z}_{L} = \frac{60}{\sqrt{{ϵ}_{r}}} \times ln ( \frac{b}{{a}_{C}} ) & ( 7 )\end{matrix}$$

In equation (6) and (7), l_{C} is the length of the respective capacitive element, a_{C} is the inner conductor structure radius of the respective capacitive element, and c_{C} is the effective propagation velocity for the respective capacitive element which equals the velocity of light in free space divided by the square root of the dielectric constant, or 0.8346×10¹⁰ in/sec in the above example.

Utilizing above equations (4) and (6) the lengths of the respective inductive and capacitive sections in the example would equal the following: l_{L1}=l_{L13}=0.156 in, l_{C2}=l_{C12}=0.069 in, l_{L3}=l_{L11}=0.380 in, l_{C4}=l_{C10}=0.084 in, l_{L5}=l_{L9}=0.416 in, l_{C6}=l_{C8}=0.086 in and l_{L7}=0.423. Additionally, if the outer conductor has an inner radius, b, 0.897 in, utilizing equations (5) and (7), the inner conductor structure radii of the inductive and the capacitive elements would equal the following: a_{L}=0.0419 in, and a_{C}=0.761 in.

After the dimensions for the realized transmission line stepped-impedance low pass filter have been determined, the stepped-impedance low pass filter can be, but need not be, optimized to adjust for differences between the theoretical, desired performance characteristics and actual, measured performance characteristics (block 102). The optimizing can be accomplished according to any of a number of different methods, but in one embodiment, the optimizing is done using a computer software package such as Optimetrics™ provided by Ansoft Corporation. Before optimizing the stepped-impedance low pass filter, the stepped-impedance low pass filter is preferably first simulated to acquire the actual, measured performance characteristics, such as by using a computer software package such as HFSS. For example, in HFSS, the dimensions calculated above would be input into the software package to acquire the performance characteristics of the above designed example stepped-impedance low pass filter. After the actual performance characteristics have been determined, the realized stepped-impedance low pass filter can be optimized to alter the dimensions of the realized stepped-impedance low pass filter to more closely align the actual performance characteristics with the desired, theoretical performance characteristics.

Once the transmission line realized stepped-impedance low pass filter has been created, the suppression elements are selected to reduce the spurious response and/or the resonant frequencies of the realized stepped-impedance low pass filter (block 104). As previously stated, the size of each suppression element is dependant upon the desired output. At least some of the suppression elements typically have different sizes to spread the remaining, reduced spurious response over a wider range of new, lower resonant frequencies, with the resonant frequencies decreasing as the diameter or size of the suppression elements increases. For example, using a software package such as HFSS, suppression elements of different sizes can be input into the software package as additions to the stepped-impedance low pass filter, with the sizes and spacing of the suppression elements taking into account the characteristics of the suppression elements outlined herein. From the input into HFSS, the performance of the resonance suppressed stepped-impedance low pass filter, can be monitored. And from the monitored output, the sizes of the suppression elements can be modified accordingly to achieve the desired output.

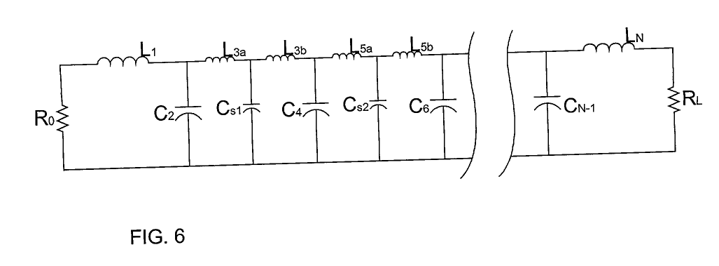

After the suppression elements have been selected, the suppression elements are disposed along the inductive elements of the stepped-impedance low pass filter, preferably centered along the inductive elements in between pairs of adjacent capacitive elements (block 106). The suppression elements will generally simulate additional capacitive elements on the lumped-element circuit, and will therefore break up each inductive section into two inductive sections, and transform the lumped-element circuit similar to that illustrated in FIG. 6. Because the widths of the suppression elements are typically small when compared with the lengths of the respective inductive elements, in embodiments where the suppression elements are centered along the inductive elements, each resulting bifurcated inductive element can be estimated to have an inductance one-half the respective original inductive element inductance.

After the suppression elements have been disposed along the inductive elements, the resulting resonant suppressed stepped-impedance low pass filter can again be, but need not be, optimized using methods similar to those described above (block 108). In this regard, the resonant suppressed stepped-impedance low pass filter can be optimized to adjust the lengths of the inductive sections to account for the small loss in inductance created by the addition of the suppression elements. Additionally, the sizes of the suppression elements can be optimized based upon actual, measured performance characteristics of the resulting resonant suppressed stepped-impedance low pass filter.

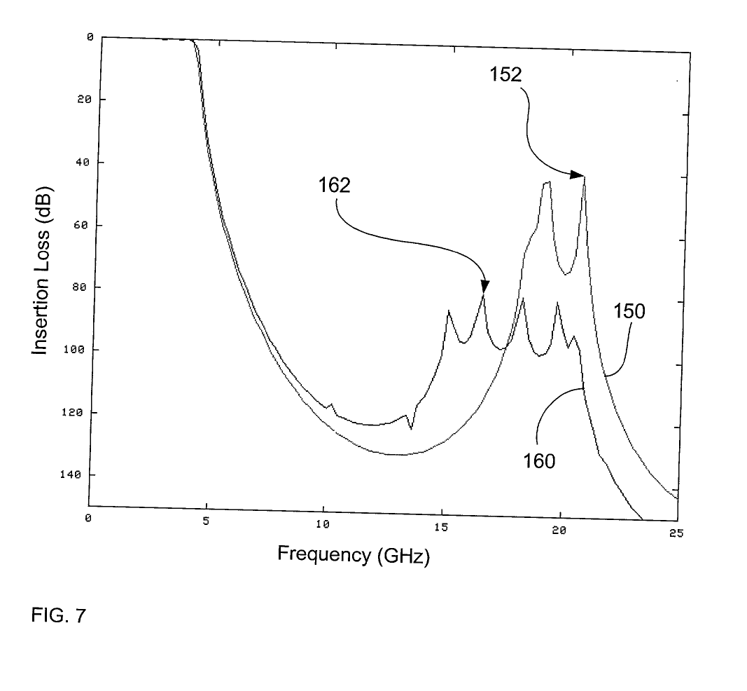

The resonance suppressed stepped-impedance low pass filter and associated method of fabrication of the present invention improve upon conventional stepped-impedance low pass filters. The resonance suppressed stepped-impedance low pass filter of the present invention reduces the spurious responses and/or resonant frequencies produced by conventional stepped-impedance low pass filters without the need for additional second low pass filters and the resulting insertion loss increase in the pass band. As shown in FIG. 7, for example, the spurious response 152, from a conventional stepped-impedance low pass filter 150 is compared with the spurious response 162 from the resonance suppressed stepped-impedance low pass filter 160, according to one embodiment of the present invention. As can be seen from the graphs in FIG. 7, both filters produce an approximate equal cut-off frequency of 3,700 MHz, and have a minimum desired insertion loss of 60 dB at 5,500 MHz. But as signals through the conventional stepped-impedance low pass filter approach and exceed resonant frequencies of 15 GHz and higher, the insertion loss decreases to a peak of approximately 40 dB, which is above the minimum insertion loss in the stop band. But the resonance suppressed stepped-impedance low pass filter reduces the spurious response to approximately 80 dB, which remains more than the minimum insertion loss. Additionally, although not illustrated, the resonant suppressed stepped-impedance low pass filter is smaller and less costly than conventional filter networks consisting of a conventional low pass filter and a second, spurious response suppressing, filter.

Many modifications and other embodiments of the invention will come to mind to one skilled in the art to which this invention pertains having the benefit of the teachings presented in the foregoing descriptions and the associated drawings. For example, although the resonance suppressed stepped-impedance low pass filter of the illustrated embodiment included a plurality of identical inductive elements and a plurality of identical capacitive elements, the inductive elements can be differently sized, such as in length and/or radius, and, likewise, the capacitive elements can be differently sized, such as in length and/or radius, if so desired. In addition, although the resonance suppressed stepped-impedance low pass filter described above included a single suppression element between each pair of adjacent capacitive elements, the resonance suppressed stepped-impedance low pass filter can include multiple suppression elements spaced apart along an inductive element between a pair of adjacent capacitive elements. Moreover, the resonance suppressed stepped-impedance low pass filter need not include suppression elements between each pair of adjacent capacitive elements in the manner illustrated. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A resonance suppressed stepped-impedance low pass filter comprising:
a stepped-impedance low pass filter comprising at least one electrically conductive transmission line having at least one inductive element and at least one capacitive element, wherein the at least one capacitive element and the at least one inductive element are disposed in an alternating manner along a length of the transmission line; and
at least one electrically conductive suppression element to suppress a spurious response at at least one resonant frequency, wherein the at least one suppression element is disposed along the at least one inductive element of the stepped-impedance low pass filter.

2. A resonance suppressed stepped-impedance low pass filter according to claim 1, wherein the at least one suppression element is centered along the at least one inductive element between a pair of capacitive elements.

3. A resonance suppressed stepped-impedance low pass filter according to claim 1, wherein the electrically conductive transmission line is a two conductor transmission line.

4. A resonance suppressed stepped-impedance low pass filter according to claim 3, wherein the two conductor transmission line is selected from a group consisting of a parallel plate transmission line, a coaxial transmission line and a two-wire transmission line.

5. A resonance suppressed stepped-impedance low pass filter according to claim 1, wherein the at least one suppression element has a capacitance, and wherein the capacitance of the at least one suppression element is selected based upon a level of the spurious response and the at least one resonant frequency in order to at least one of reduce the spurious response and reduce the at least one resonant frequency.

6. A resonance suppressed stepped-impedance low pass filter according to claim 1, wherein the at least one inductive element and the at least one capacitive element are selected based upon at least one performance characteristic selected from a group consisting of a predetermined cut-off frequency, a predetermined minimum insertion loss at a specified frequency, a filter impedance, a maximum and a minimum transmission line impedance in order to produce a predetermined response over a predetermined frequency range.

7. A stepped-impedance low pass filter having at least one electrically conductive transmission line, wherein at least a portion of the at least one transmission line comprises:
at least one base element comprising a first portion and a second portion, wherein the first portion has a lower impedance than that of the second portion; and
at least one intermediate element disposed along the second portion of said at least one base element, wherein the at least one intermediate element has an impedance lower than the second portion, and wherein the at least one intermediate element has an impedance larger than the first portion.

8. A stepped-impedance low pass filter according to claim 7, wherein said at least one base element is at least two base elements, wherein the second portion of said at least one base element is connected to the first portion of a subsequent base element such that said at least one intermediate element is disposed between a pair of first portions.

9. A stepped-impedance low pass filter according to claim 8 wherein said at least one intermediate element is centered along the second portion of said at least two base elements.

10. A stepped-impedance low pass filter according to claim 8 further comprising a dielectric disposed between each pair of first portions.

11. A stepped-impedance low pass filter according to claim 10, wherein said dielectric is air.

12. A stepped-impedance low pass filter having at least one electrically conductive transmission line, wherein the at least one transmission line extends longitudinally, and wherein at least a portion of the at least one transmission line comprises:
at least one electrically conductive element, wherein each electrically conductive element is spaced apart from adjacent electrically conductive elements, wherein each electrically conductive element is connected to adjacent electrically conductive elements by at least one electrically conductive connecting member, and wherein each electrically conductive element has a larger lateral size than the adjacent connecting members; and
at least one intermediate element disposed along the at least one connecting member in between an adjacent pair of electrically conductive elements, wherein the at least one intermediate element has a larger lateral size than the respective connecting member, and wherein the at least one intermediate element has a smaller lateral size than the respective adjacent pair of electrically conductive elements.

13. A stepped-impedance low pass filter according to claim 12 wherein each intermediate element is centered along the respective connecting member in between the pair of adjacent electrically conductive elements.

14. A method for fabricating a resonance suppressed stepped-impedance low pass filter comprising:
creating a stepped-impedance low pass filter comprising at least one electrically conductive transmission line having at least one inductive element and at least one capacitive element; and
disposing at least one electrically conductive suppression element along the at least one inductive element to suppress a spurious response at at least one resonant frequency.

15. A method according to claim 14, wherein disposing the at least one suppression element along the at least one inductive element comprises centering the at least one suppression element along the at least one inductive element between a pair of capacitive elements.

16. A method according to claim 14, wherein the at least one suppression element has a capacitance, and wherein the method further comprises selecting the capacitance of the at least one suppression disk based upon a level of the spurious response and the at least one resonant frequency in order to at least one of reduce the spurious response and reduce the at least one resonant frequency.

17. A method according to claim 16, wherein creating the stepped-impedance low pass filter comprises:
creating the stepped-impedance low pass filter based upon at least one theoretical performance characteristic; and
optimizing the stepped-impedance low pass filter based upon at least one actual performance characteristic.

18. A method according to claim 17, wherein the at least one theoretical performance characteristic is selected from a group consisting of a predetermined cut-off frequency, a predetermined minimum insertion loss at a specified frequency, a filter impedance, a maximum and a minimum transmission line impedance.

19. A method according to claim 18, wherein the at least one actual performance characteristic is selected from a group consisting of a measured cut-off frequency, a measured insertion loss at the specified frequency, a measured filter impedance, a measured maximum and a measured minimum transmission line impedance.

20. A method according to claim 14 further comprising optimizing the resonance suppressed stepped-impedance low pass filter after disposing the at least one suppression element along the at least one inductive element, wherein optimizing the resonance suppressed stepped-impedance low pass filter is based upon at least one actual performance characteristic.

21. A method according to claim 20, wherein the at least one actual performance characteristic is selected from a group consisting of a measured cut-off frequency, a measured insertion loss at a specified frequency, a measured filter impedance, a measured maximum and a measured minimum transmission line impedance.
